(19) United States
(12) Patent Application Publication
(10) Pub. No.: US 2026/0048582 A1
(43) Pub. Date: Feb. 19, 2026

(54) DEVICE FOR APPLYING HOT ADHESIVE POWDER TO PRINT MEDIA

(71) Applicant: Mike HEUSCHKEL, Lüdenscheid (DE)

(72) Inventor: Mike HEUSCHKEL, Lüdenscheid (DE)

(21) Appl. No.: 19/103,570

(22) PCT Filed: Apr. 13, 2023
(86) PCT No.: PCT/EP2023/059655

§ 371 Date: Feb. 21, 2025

(30) Foreign Application Priority Data
Sep. 6, 2022 (DE) 20 2022 001 966.1

(51) Int. Cl. B41F 23/04; B41J 11/00

(52) U.S. Cl. CPC B41F 23/0483; B41J 11/0022

(57) ABSTRACT

A device for applying hot adhesive powder to print media is constructed as an aluminum frame. The frame forms a support surface similar to a bench on which a printer can be placed. The print medium is conveyed from the printer through a powder unit and to a winding device via deflection rollers.

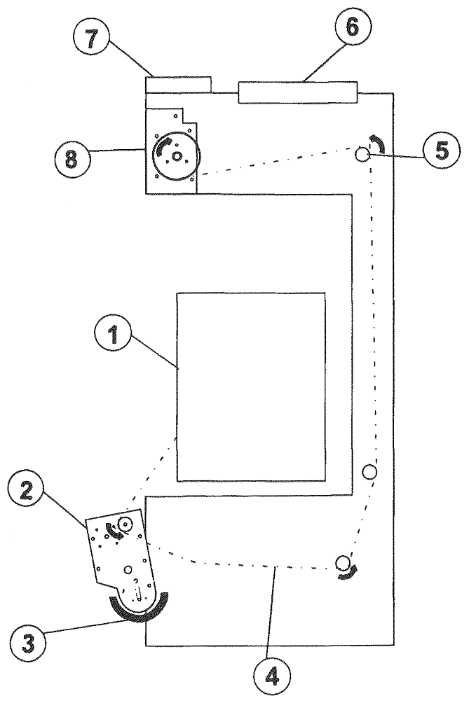

The invention relates to an apparatus for applying hot adhesive powder to print media.

The present invention essentially relates to imprinting of textiles. These are frequently imprinted with motifs, for example images, logos, texts or the like. The manner of imprinting takes place according to what is called the direct-to-film method (DTF method), in German something like “direct printing to film.” In this regard, the desired design or motif is generally drawn up on a computer. The completed design is then mirror-imaged, something that is particularly important in the case of texts, so that these can be read after being applied to the article of clothing.

The print media are generally a transfer film. The film is usually a PET film. It can be used in the form of sheets or as an endless film that is wound up onto a roller.

In the case of individual single printing for private or commercial use, the sheet-type transfer film is laid into an inkjet or laser printer and the printing process for the design is started. After printing has been completed, a cover film situated on the transfer film is removed. In the next step, an iron is heated up and the article of clothing is laid onto a smooth surface, for example an ironing board. Then the transfer film that has been provided with the motif is laid onto the article of clothing, and the film is ironed, using the iron, until the film adheres to the article of clothing. In the commercial sector, what are called transfer presses are used in place of an iron.

Larger devices are used for serial imprinting of articles of clothing. In these devices, the endless transfer film that is wound up onto a roller is used. The roller is clamped into a transport device. From there, the transfer film is unwound and conveyed through a printer, which is also an inkjet or laser printer. In this printer, the desired motifs are printed onto the transfer film. After imprinting of the transfer film, the latter is conveyed horizontally in the direction of a powder unit that is arranged adjacent to the printer. In the powder unit, the film is drawn, with the application of pressure, through a storage container, in which a thermal fixation powder, also called a hot adhesive powder colloquially, is situated. This powder adheres to the imprinted locations of the film. The powder falls off the non-imprinted regions of the film into a collection container, using a shaking device. Subsequently the film is conveyed through a heating and drying system that is arranged adjacent to the powder unit. In this system, the fixation powder forms a gel. At the end of the system, the film is wound up onto a roller.

For imprinting onto the textiles, in each instance, the film is unwound and positioned on a textile that is situated in a transfer press. Then the press is closed, whereupon a pressure as well as heat are exerted on the textile and the film. After the press is opened, the film is pulled off; what remains is merely the motif on the textile.

Apparatuses for a surface of the print medium in the form of the film, which surface is to be treated after printing, are generally set up in front of the printer so as to allow horizontal transport, and take up space there. The need for setup space is therefore great. Conventional powder machines for textile printers furthermore require regular decanting of the excess powder by hand, because the powder that has fallen down must be transported back into the supply container from the collection container. Furthermore, during transport of the film through the powder, static charging of the film occurs, and this leads to the result that the powder partially adheres to the film even at locations that are not imprinted. This can lead to quality losses during application of the motif to the textile.

Against this background, the invention is based on the task of creating an apparatus for applying hot adhesive powder to print media, which apparatus has a compact construction and therefore requires a smaller installation surface than is the case for the apparatuses known from the state of the art. According to the invention, this is accomplished with the characteristics of claim 1.

The invention indicated in claim 1 eliminates the space problem known from the state of the art, by means of the manner of construction of the apparatus, since here the printer is placed into the machine.

The invention indicated in claim 2 allows a space-saving design, because the powder unit is arranged below the printer.

Claim 3 allows elimination of decanting the powder by hand. The powder is continuously spread onto the print medium. Excess coating material gets into the supply trough, from which it is subsequently transported back to the medium.

The invention indicated in claim 4 facilitates feed of the medium roller, so as to roll up the print medium and to remove it.

Other further developments and embodiments of the invention are indicated in the remaining dependent claims. An exemplary embodiment of the invention is shown in the drawing and will be described in detail below. The single FIGURE shows a schematic representation of the apparatus according to the present invention.

The apparatus selected as the exemplary embodiment is built as an aluminum frame that has essentially a C shape. The frame forms a support surface similar to a bench. The printer 1 is placed into the apparatus. It is placed on the support surface and is freely accessible from the front of the apparatus. In the printer 1, the medium 4 to be imprinted is arranged as an endless film wound up onto a roller. In the exemplary embodiment, the medium 4 to be imprinted is a transfer film, in the form of a PET film. The film is heat-resistant and coated for digital printing.

In the printer 1, the medium 4 is imprinted with the desired motifs. The imprinted medium 4 is transported out of the printer by way of deflection rollers 1, to a winding apparatus 8 that is arranged above the printer 1. For this purpose, a drive is built into the apparatus. The drive can drive the roller in the printer 1. Likewise, the winding apparatus 8 can be provided with a drive. Furthermore, all the deflection rollers 5 or individual ones can be provided with a drive. In this regard, the medium 4 passes through a powder unit 2 that spreads powder onto the medium 4. The powder is a thermal fixation powder or hot adhesive powder.

The powder unit 2 is positioned in the region of the apparatus that faces the ground, i.e., it is situated on the bottom side of the apparatus. It is arranged below the printer 1. The powder unit 2 conveys the powder out of a supply trough 3 onto the medium 4. For this purpose, a conveying device is provided, which is equipped with chains or optionally with a toothed belt drive. These can be provided with scoops. Alternatively, the powder can be conveyed upward by means of a spindle. The powder adheres to the imprinted locations of the film 4; excess powder drops back into the supply trough 3.

The medium 4 is heated, together with the powder, by a heat source 6, and thereby the powder forms a gel. The heat source 6 can be configured in the manner of a heating mat or plate, or also in the form of a radiant heater. The exhaust air is filtered by a suctioning component 7 and applied to the medium 4 as drying air. In this way, cooling of the medium 4 takes place at the same time. In the region of the suctioning component 7, a lid, not shown, is formed, which releases the suctioning component 7 in the open state and thereby allows maintenance and/or replacement of filter elements. Supplemental to the exemplary embodiment, fans for cooling can be additionally arranged in the region of the suctioning component 7. The winding apparatus 8 winds the imprinted, coated, and dried medium 4 up again. For this purpose, a roller is suspended into the winding apparatus 8, which roller is usually made of paperboard. To simplify handling, the roller is magnetically fixed in place in the winding apparatus 8. Adapter plates can also be used, which are adapted to the configuration of the end-face ends of the rollers.

The apparatus is provided with sensors, not shown, which monitor the movement of the print medium 4 in the apparatus. Using the sensors, it can be determined whether the medium 4 is being transported at a uniform speed. Furthermore, it can be determined whether the print medium 4 is running out. As soon as the sensors determine a deviation or the like, the operator can be informed; this can take place acoustically and/or optically, for example.

Likewise, monitoring takes place in the powder unit 2, including the fill level of the powder as well as the function of the conveying device. The same holds true for the printer 1, in which monitoring of the printing inks is provided.

In the apparatus, threading aids are arranged at various locations. In particular, such aids are installed in the region of the powder unit 2 as well as of the winding apparatus 8, so as to guarantee error-free transport of the print medium 4.

Furthermore, the apparatus can have a chain hoist that can be activated by way of a crank, so as to simplify threading the print medium 4 into place; using this hoist, the print medium 4 can be conveyed upward in the direction of the winding apparatus 8. In this way, the possibility of manual threading is created, so that automated operation is only started after proper placement of the beginning of the print medium 4 against the roller.

The apparatus according to the invention has a very compact construction in comparison with the apparatuses for applying hot adhesive powder to print media that are known from the state of the art. The reason for this is that the printer 1 is set into the frame of the apparatus, and the powder unit 2—contrary to the state of the art-is arranged below the printer 1. At the same time, the winding apparatus 8 as well as the heat source 6 and the suctioning and drying component 7 are arranged above the printer 1. Consequently, the apparatus according to the invention has a significantly smaller space requirement than the apparatuses known from the state of the art, in which printer, powder unit, heat source, suctioning, drying, and winding apparatus are arranged next to one another in a horizontal orientation. Consequently, the space requirement is significantly greater than in the case of the apparatus according to the invention. In contrast to the state of the art, in which the transport of the print medium takes place in the horizontal direction, in the case of the invention the transport of the print medium 4 takes place essentially in the vertical direction.

Due to the space-saving construction of the apparatus according to the invention, the possibility exists of providing the frame with rollers, so that the apparatus can be moved within the installation space. This can be accomplished by a single person.

The placement of the printer 1 in the aluminum frame, on the support surface, and because of its placement on the front side of the apparatus, the printer 1 is freely accessible. As a result, in contrast to the apparatuses known from the state of the art, in which the powder unit, heat source, suctioning, drying, and winding apparatus are positioned in front of the printer, problem-free replacement of the rollers in the printer is possible.

By means of the positioning of the winding apparatus 8 above the printer 1 on the front side of the apparatus, very user-friendly handling when putting the roller in place or removing it is made possible. The winding apparatus 8 is also freely accessible from the front. Therefore the roller can be replaced from the front. The winding apparatus 8 is arranged approximately at shoulder height, so that it is easy to reach.

1. An apparatus for applying hot adhesive powder to print media (4), wherein the apparatus is constructed as an aluminum frame that forms a support surface similar to a bench, on which a printer (1) can be placed.

2. The apparatus according to claim 1, wherein a powder unit (2) is situated on the bottom side.

3. Apparatus according to claim 2, wherein the powder unit (2) is equipped with chains or a toothed belt drive.

4. The apparatus according tor claim 1, wherein a winding apparatus (8) as well as a heat source (6) are mounted on its upper end.

5. The apparatus according to claim 1, wherein the print medium (4) can be transported out of the printer (1) by way of deflection rollers (5), to the winding apparatus (8).

6. The apparatus according to claim 1, wherein the powder unit (2) is arranged below the printer (1) and the winding apparatus (8) is arranged above the printer (1).

7. The apparatus according to claim 1, wherein a drive is built in.

8. The apparatus according to claim 7, wherein the drive drives the roller in the printer (1).

9. The apparatus according to claim 7, wherein the winding apparatus (8) is provided with a drive.

10. The apparatus according to claim 7, wherein at least one deflection roller (5) is provided with a drive.
